(19) United States
(12) Patent Application Publication
(10) Pub. No.: US 2015/0001369 A1
(43) Pub. Date: Jan. 1, 2015

(54) MOUNTING APPARATUS FOR STOREHOUSE OF VENDING MACHINE

(71) Applicants: Hong Fu Jin Precision Industry (WuHan) Co., Ltd. ., Wuhan (CN); Hon Hai Precision Industry Co., Ltd., New Taipei (TW)

(72) Inventors: YUN-LUNG CHEN, New Taipei (TW); GANG SU, Wuhan (CN); WEI-YONG MA, Wuhan (CN); REN-XI DOU, Wuhan (CN); LIANG TU, Wuhan (CN); ZHI-WU XIA, Wuhan (CN)

(73) Assignees: HONG FU JIN PRECISION INDUSTRY (WuHan) CO., LTD., Wuhan (CN); HON HAI PRECISION INDUSTRY CO., LTD., New Taipei (TW)

(21) Appl. No.: 14/256,507

(22) Filed: Apr. 18, 2014

(30) Foreign Application Priority Data
Jun. 28, 2013 (CN) 2013102640027

(51) Int. Cl. F16M 13/02; F16B 45/00

(52) U.S. Cl. CPC F16M 13/02; F16B 45/00
USPC 248/672; 248/681

(57) ABSTRACT

A mounting apparatus for a storehouse in a vending machine is disclosed. The mounting apparatus includes a base, a limiting member, and an installation member. The base is configured for holding a storehouse and includes two blocking plates configured for receiving the storehouse therebetween. The installation member movably mounts the limiting member to one of the two blocking plates. A portion of the limiting strip is located between the two blocking plates to abut a side surface of the storehouse, preventing the storehouse from tilting in a direction substantially parallel to the two blocking plates.

### FIELD

The present disclosure relate to mounting apparatuses, and more particularly to a mounting apparatus for a storehouse in a vending machine.

### BACKGROUND

A direct-type vending machine generally includes a housing and a number of storehouses vertically installed in the housing. The housing includes a top frame and a base. Each storehouse includes a top bracket secured to the top frame and a number of receiving boxes secured to the top frame. The base holds the number of receiving boxes.

### BRIEF DESCRIPTION OF THE DRAWINGS

Many aspects of this disclosure can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a mounting apparatus and a storehouse.

FIG. 2 is an enlarged view of circled portion II of the mounting apparatus of FIG. 1.

FIG. 3 is an assembled, isometric view of the mounting apparatus and the storehouse of FIG. 1, showing a limiting member in a blocked position.

FIG. 4 is similar to FIG. 3, but viewed from a different aspect.

FIG. 5 is an enlarged view of circled portion V of the mounting apparatus and the storehouse of FIG. 3.

FIG. 6 is an enlarged view of circled portion VI of the mounting apparatus and the storehouse of FIG. 4.

FIG. 7 is similar to FIG. 3, but showing the limiting member in a released position.

FIG. 8 is an enlarged view of circled portion VIII of the mounting apparatus and the storehouse of FIG. 7.

FIG. 9 is similar to FIG. 7, but viewed from a different aspect.

### DETAILED DESCRIPTION

The disclosure is illustrated by way of example and not by way of limitation in the figures of the accompanying drawings. It should be noted that references to “an” or “one” embodiment in this disclosure are not necessarily to the same embodiment, and such references mean “at least one.”

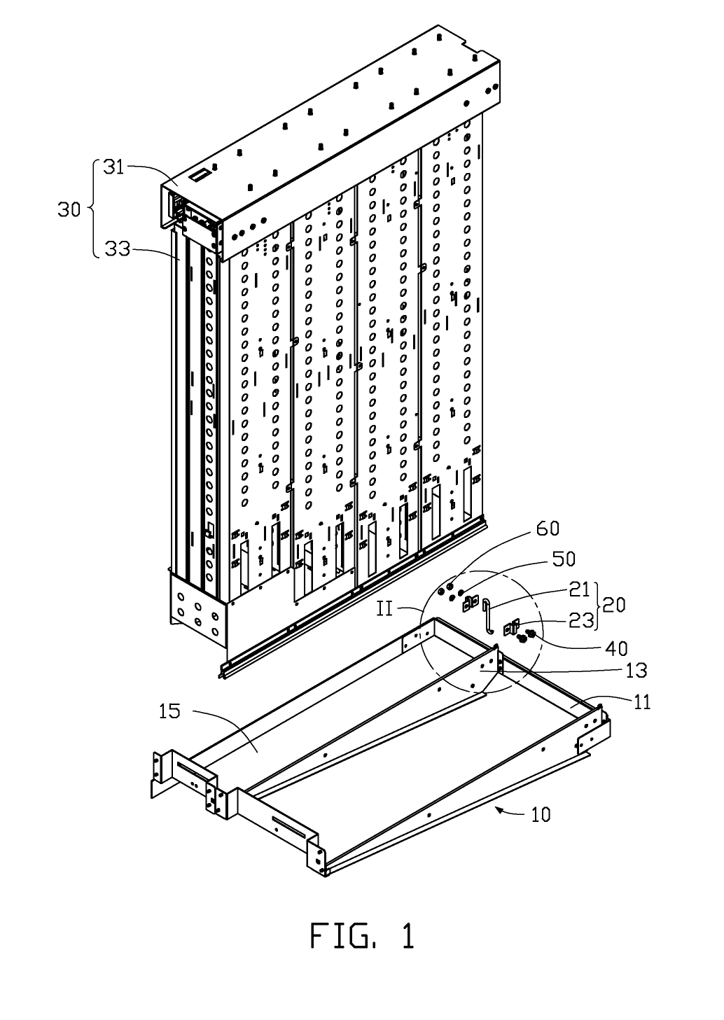

FIG. 1 illustrates one embodiment of a mounting apparatus of a vending machine. The mounting apparatus includes a base 10 for placing a storehouse 30 and a limiting assembly 20.

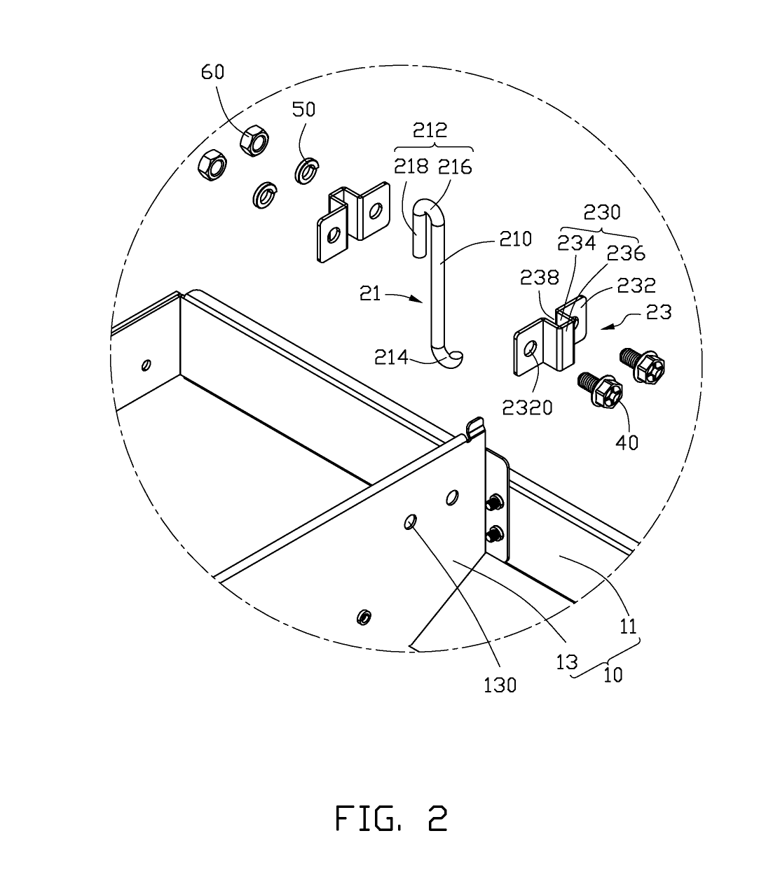

FIG. 1 and FIG. 2 illustrate that the base 10 includes a bottom wall 15, two sidewalls 11, and a plurality of blocking plates 13 secured to the bottom wall 15 and located between the two sidewalls 11. Each blocking plate 13 defines two mounting holes 130 adjacent to one of the two sidewalls 11.

The limiting assembly 20 includes a limiting member 21 and two installation members 23. The limiting member 21 includes a latching portion 214, a connecting strip 210, and a limiting portion 212. The latching portion 214 and the limiting portion 212 extend from opposite ends of the connecting strip 210. The limiting portion 212 includes a blocking end 216 and a limiting strip 218. The blocking end 216 connects the limiting strip 218 to the connecting strip 210. The limiting strip 218 is substantially parallel to the connecting strip 210. In at least one embodiment, each of the blocking end 216 and the latching end 214 is curved, and the limiting member 21 is substantially an “S” shaped. Each installation member 23 includes two installation pieces 232 and a receiving portion 230 connected between the two installation pieces 232. The receiving portion 230 includes a connecting piece 236 and two limiting pieces 234 connecting the two installation pieces 232. A receiving space 238 is defined cooperatively by the two limiting pieces 234 and the connecting piece 236. Each installation piece 232 defines an installation hole 2320. In one embodiment, the connecting piece 236 is substantially parallel to two installation pieces 232 and substantially perpendicular to the two limiting pieces 234.

The storehouse 30 includes a top bracket 31 and a receiving box assembly 33 secured to the top bracket 31.

The mounting apparatus further comprises two fasteners 40, two resilient washers 50, and two nuts 60.

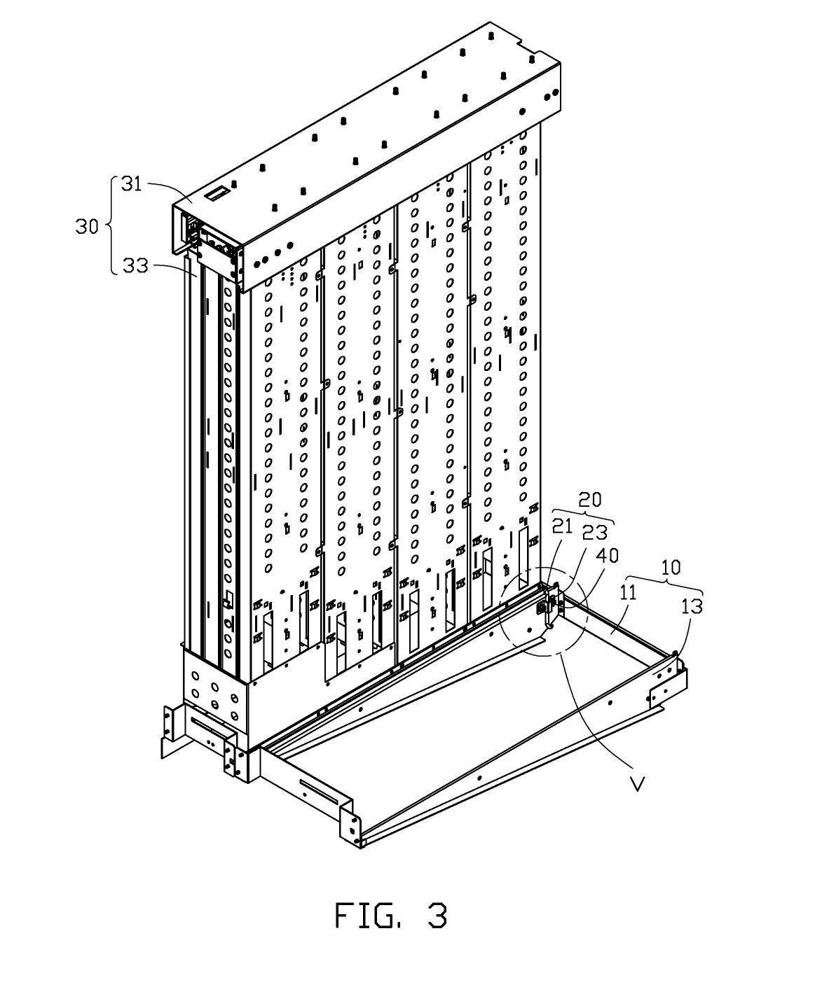

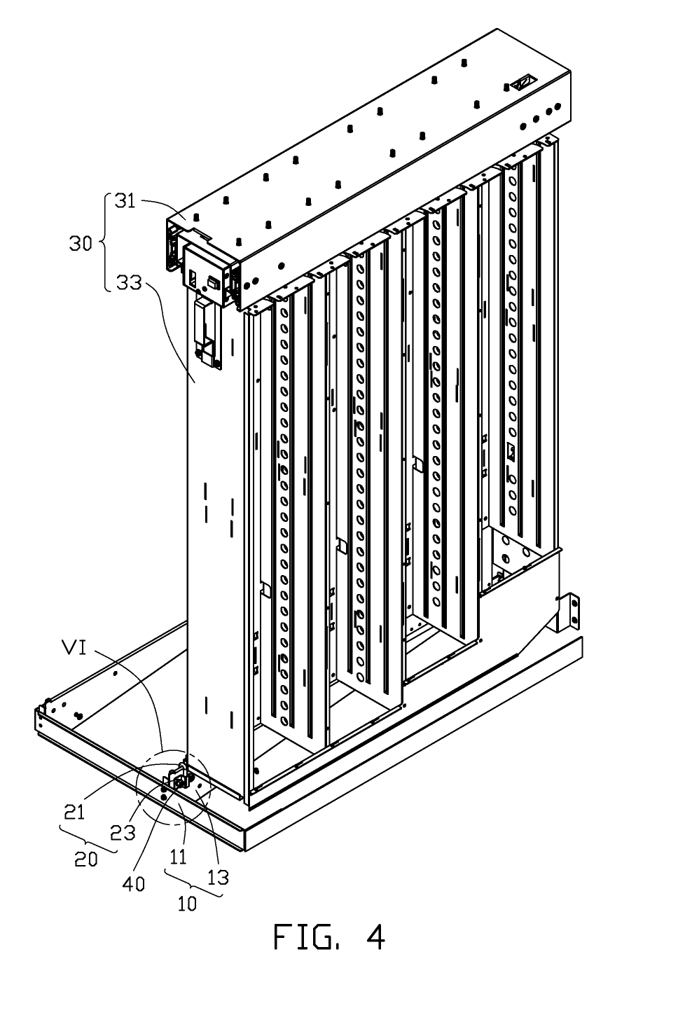

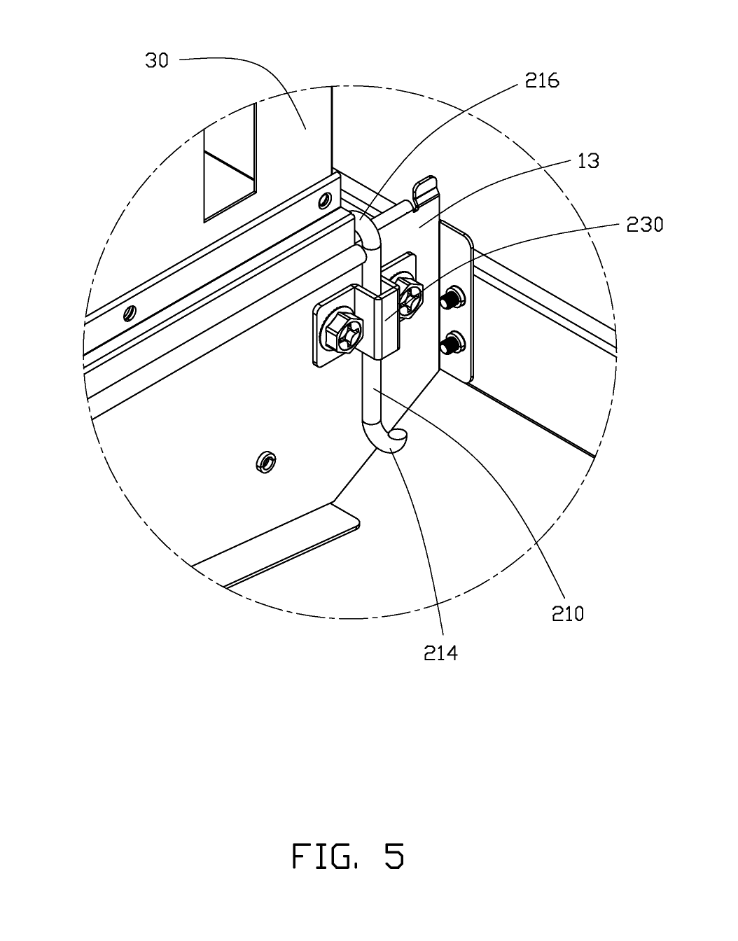

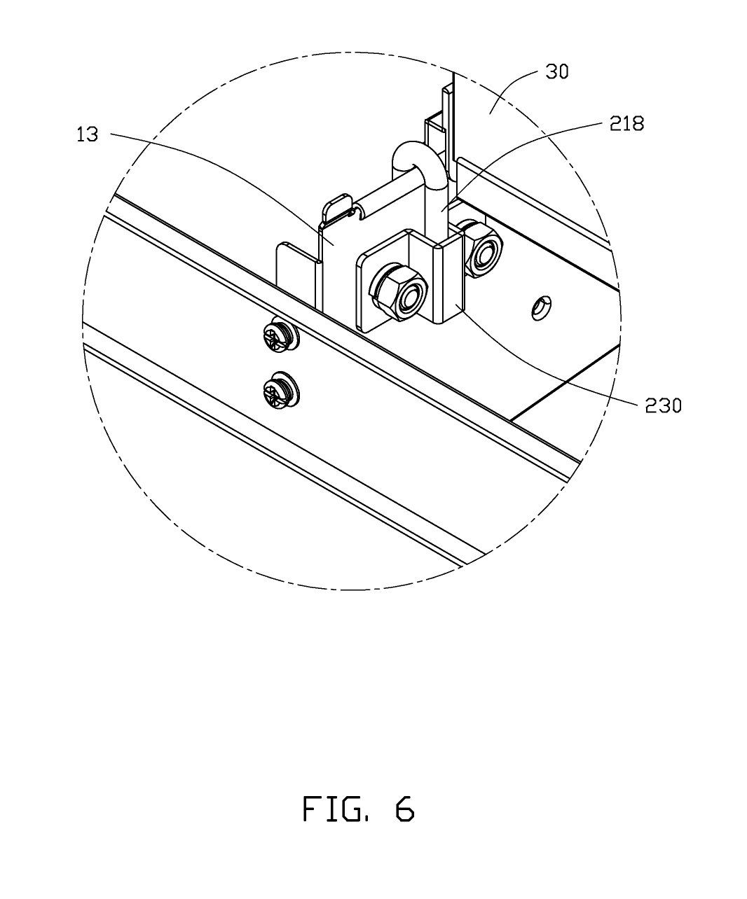

FIGS. 3-6 illustrate that in assembly, the storehouse 30 is placed between the two sidewalls 11 one sidewall 11. The limiting member 21 is moved towards the blocking plate 13 in a blocking position, where the blocking plate 13 is received between the limiting strip 218 and the connecting strip 210, and the blocking end 216 abuts a top edge of the blocking plate 13. A plane defined by the blocking strip 218 and the connecting strip 210 can be substantially perpendicular to the blocking plate 13. The two installation members 23 are placed on opposite sides of the blocking plate 13 with the installation holes 2320 aligned with the mounting holes 130. The connecting strip 210 is received in the receiving space 238 of one installation member 23. The limiting strip 218 is received in the receiving space 238 of the other installation member 23. Each fastener 40 can be inserted through the installation holes 2320 of the two installation members 23, the resilient washer 50, and the mounting hole 130, and then each nut 60 is secured to the fastener 40 to secure the limiting assembly 20 to the blocking plate 13. A distance between the limiting strip 218 and the one sidewall 11 is substantially equal to a length of the storehouse 30. A distance between the two blocking plates 13 is substantially equal to a width of the storehouse 30. The limiting strip 218 and the blocking end 216 abuts a side surface of the storehouse 30. When the vending machine is moved, the limiting member 21 and the one sidewall 11 prevent the storehouse 30 from waggling along a first direction substantially parallel to the blocking plate 13.

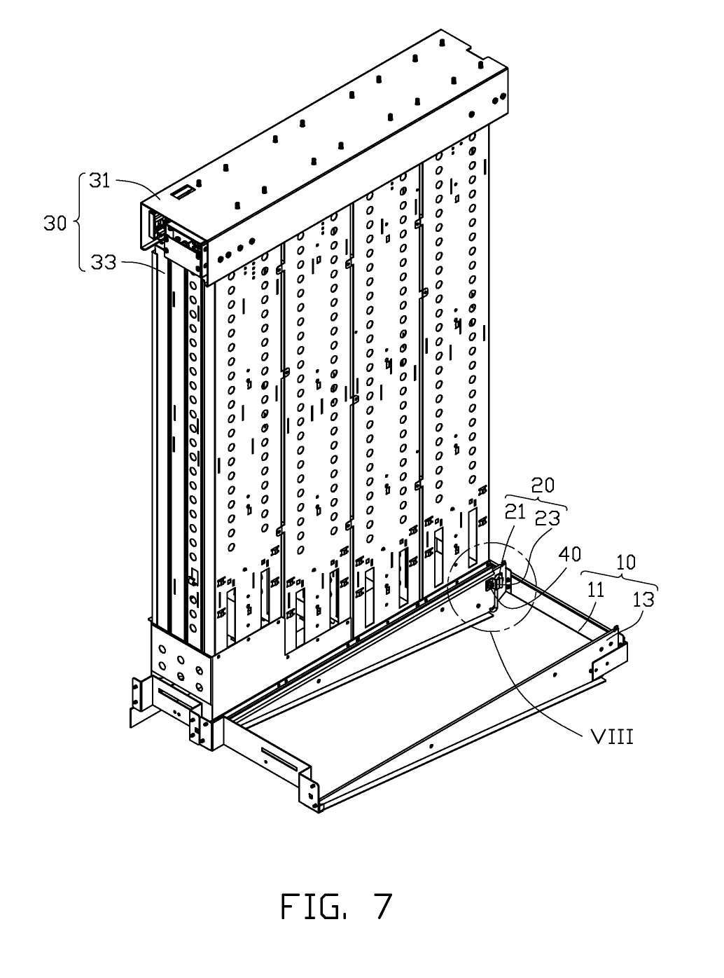

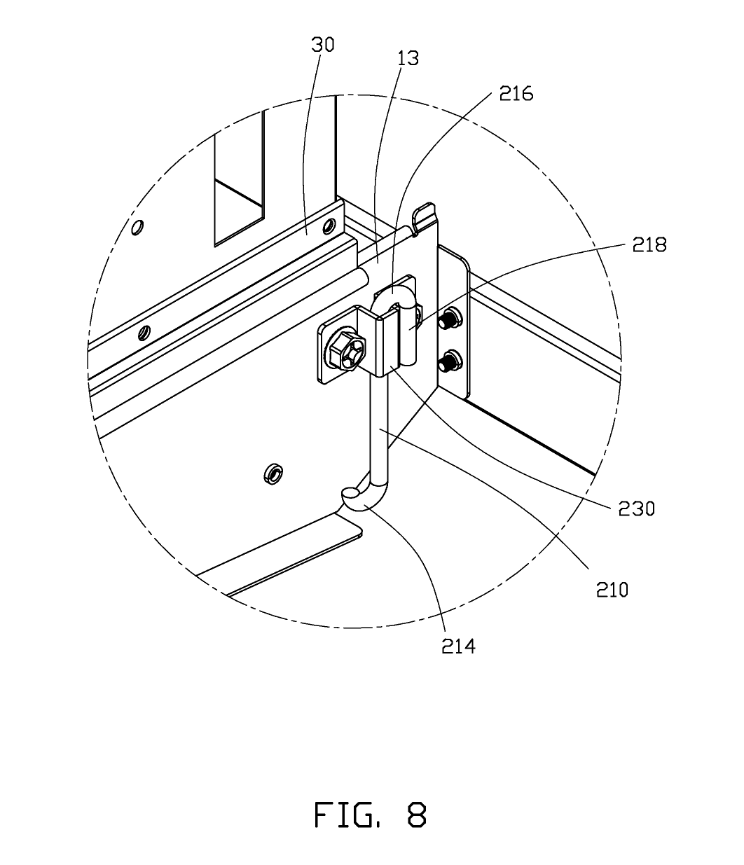

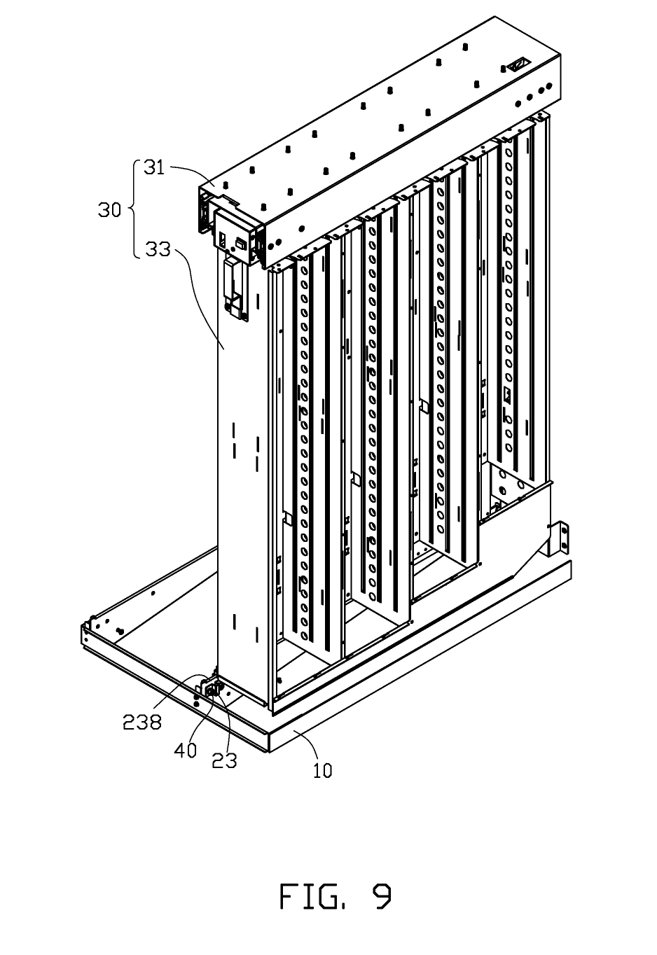

FIGS. 7-9 illustrate that when the storehouse 30 is needed to be removed from the base 10 or reassembled with the base 10, the latching portion 214 is pushed in a second direction, substantially perpendicular to the first direction, to move the limiting member 21 upwards, causing the limiting strip 218 to disengage from the receiving space 238. The limiting member 21 is rotated outwards until completely located in a side of the blocking plate 13. The plane defined by the blocking strip 218 and the connecting strip 210 is substantially parallel to the blocking plate 13. The latching end 214 abuts edge of the receiving portion 230 when the limiting member 21 is moved upwards, preventing the limiting member 21 from moving out of the receiving space 238.

It is to be understood that even though numerous characteristics and advantages have been set forth in the foregoing description of embodiments, together with details of the structures and functions of the embodiments, the disclosure is illustrative only and changes may be made in detail, including in the matters of shape, size, and the arrangement of parts within the principles of the disclosure. The embodiments described herein are illustrative, and should not be construed as limiting the following claims.

What is claimed is:

1. A mounting apparatus comprising:
a base configured for holding a storehouse and comprising two blocking plates configured for receiving the storehouse therebetween and a sidewall configured for abutting a first side surface of the storehouse;
a limiting member comprising an limiting strip, a connecting strip, and a blocking end connected between the limiting strip and the connecting strip; and
an installation member movably mounting the limiting member to one of the two blocking plates;
wherein the sidewall is substantially perpendicular to the two side plates; the limiting strip and the connecting strip are located on opposite sides of the one of the two blocking plates; and the limiting strip is located between the two blocking plates and configured for abutting a second side surface of the storehouse, thereby preventing the storehouse from wobbling in a direction substantially parallel to the two blocking plates.

2. The mounting apparatus of claim 1, wherein the installation member comprises an installation piece and a receiving portion, the installation piece is secured to the one the two blocking plates, and the connecting strip is slidably received in the receiving portion.

3. The mounting apparatus of claim 2, wherein the receiving portion comprises a connecting piece and two limiting pieces, a receiving space is defined cooperatively by the connecting piece and the two limiting pieces, and the connecting strip is received in the receiving space.

4. The mounting apparatus of claim 1, wherein the limiting member further comprises a latching end extending from the connecting strip, and the latching end engages with edge of the receiving portion when the connecting strip is slid in the receiving space, preventing the connecting strip from sliding out of the receiving space.

5. The mounting apparatus of claim 4, wherein each of the blocking end and the latching end is curved.

6. The mounting apparatus of claim 1, further comprising another installation member secured to the one of the two blocking plate, wherein another installation member defines another receiving space and receives the limiting strip in another receiving space.

7. The mounting apparatus of claim 6, wherein the latching end is operable to move the limiting member to a released position, where the limiting strip is disengaged from the receiving space, and the limiting strip and the connecting strip are located outside of the two blocking plates.

8. The mounting apparatus of claim 7, wherein the connecting strip is substantially parallel to the limiting strip.

9. The mounting apparatus of claim 8, wherein when the limiting member blocks the storehouse, a plane defined by the connecting strip and the limiting strip is substantially perpendicular to each blocking plate; and when the limiting member is in the released position, the plane is substantially parallel to each blocking plate.

10. The mounting apparatus of claim 1, wherein the limiting member is substantially an “S” shaped.

11. A mounting apparatus comprising:
a base configured for holding a storehouse and comprising two blocking plates configured for receiving the storehouse therebetween and a sidewall configured for abutting a first side surface of the storehouse;
a limiting member comprising an limiting strip, a connecting strip, and a blocking end connected between the limiting strip and the connecting strip; and
an installation member movably mounting the limiting member to one of the two blocking plates;
wherein the sidewall is substantially perpendicular to the two side plates; the limiting member is alternatively located in the one of the two blocking plates in a blocked position or a released position; when the limiting member in the blocked position, the limiting strip and the connecting strip are located on opposite sides of the one of the two blocking plates, and the limiting strip is located between the two blocking plates and configured for abutting a second side surface of the storehouse, preventing the storehouse from wobbling in a direction substantially parallel to the two blocking plates; and when the limiting member in the released position, the limiting strip and the connecting strip are located outside of the two blocking plates, allowing the storehouse to move in the direction substantially parallel to the two blocking plates.

12. The mounting apparatus of claim 11, wherein the installation member comprises an installation piece and a receiving portion, the installation piece is secured to the one the two blocking plates, and the connecting strip is slidably received in the receiving portion when the limiting member is in the blocked position.

13. The mounting apparatus of claim 12, wherein the receiving portion comprises a connecting piece and two limiting pieces, a receiving space is defined cooperatively by the connecting piece and the two limiting pieces, and the connecting strip is received in the receiving space.

14. The mounting apparatus of claim 11, wherein the limiting member further comprises a latching end extending from the connecting strip, and the latching end engages with edge of the receiving portion when the connecting strip is slid in the receiving space, preventing the connecting strip from sliding out of the receiving space.

15. The mounting apparatus of claim 14, wherein each of the blocking end and the latching end is curved.

16. The mounting apparatus of claim 11, further comprising another installation member secured to the one of the two blocking plate, wherein another installation member defines another receiving space configured for receiving the limiting strip in another receiving space.

17. The mounting apparatus of claim 16, wherein when the limiting member is in the blocked position, the limiting strip is received in another receiving space, and when the limiting member is in the released position, the limiting strip is disengaged from the receiving space.

18. The mounting apparatus of claim 11, wherein the connecting strip is substantially parallel to the limiting strip.

19. The mounting apparatus of claim 18, wherein when the limiting member is in the blocked position, a plane defined by the connecting strip and the limiting strip is substantially perpendicular to each blocking plate; and when the limiting member is in the released position, the plane is substantially parallel to each blocking plate.

20. The mounting apparatus of claim 11, wherein the limiting member is substantially an “S” shaped.
